(19) United States
(12) Patent Application Publication
(10) Pub. No.: US 2010/0177768 A1
(43) Pub. Date: Jul. 15, 2010

(54) METHOD TO ADAPT THE ROUTING OF A CUSTOMER'S COMMUNICATIONS WITHIN AN IMS TYPE NETWORK

(76) Inventors: Olivier Durecu, Nozay (FR); Patrick Legrand, Nozay (FR)

Correspondence Address: FAY SHARPE/LUCENT, 1228 Euclid Avenue, 5th Floor, The Halle Building, Cleveland, OH, 44115-1843, US

(21) Appl. No.: 12/520,603

(22) PCT Filed: Dec. 19, 2007
(86) PCT No.: PCT/EP2007/064208

§ 371 Date: Mar. 3, 2010

(30) Foreign Application Priority Data
Dec. 22, 2006 (FR) 0655886

(51) Int. Cl. H04L 12/66

(52) U.S. Cl. 370/352; 379/220.01

(57) ABSTRACT

The invention concerns a method for the adaptation of the routing of the communications of a Customer (C) within an IMS type network, the said method providing for the ability of the Customer (C) to transmit additional routing rules (2), and wherein the said additional routing rules are concatenated with the routing rules (1) defined by the IMS network operator, such concatenated routing rules (3) being subsequently available for use by the IMS network to adapt the routing of the customer's communications as a function of his/her needs. The invention also pertains to an IMS type network.

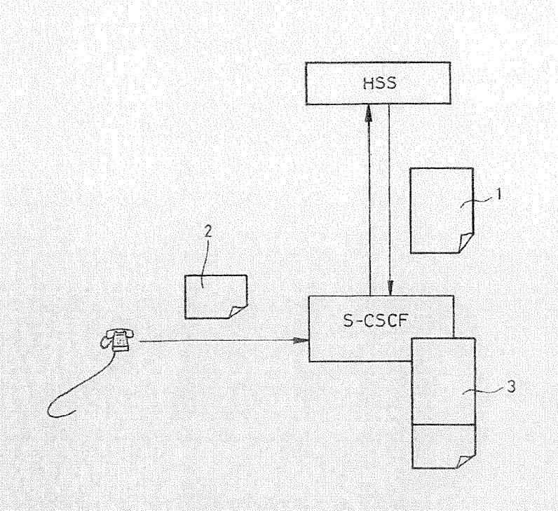

This application is based on and claims the benefit of PCT Patent Application no. PCT/EP2007/064208 filed on 19 Dec. 2007, which is incorporated by reference herein in its entirety

The invention concerns a method to adapt the routing of a customer's communications within an IMS type network. The invention also relates to an IMS type network.

### TECHNICAL FIELD

Developments in telecommunications have enabled a growing number of customers to possess one or more terminals, such as mobile or cellular telephones, computers, or personal digital assistants, which are able to communicate via one or more communication networks of different types, i.e. using discrete communication protocols. To enable communication between networks operating under different protocols, a standardized architecture called IMS (Internet Protocol Multimedia Subsystem) was developed under the 3GPP standard.

An IMS network uses a protocol called IP (Internet Protocol) enabling it, in particular, to transmit data in the form of packets, each packet comprising a header indicating an IP address of the addressee of the packets, so that the packets can follow different paths to arrive at their destination. The IP protocol enables the IMS network to receive or transmit data from different networks associated to the said IMS network and encoded under different protocols, each being specific to each such network.

In an IMS type network, a customer has several identities corresponding to profiles stored in a data storage device of HSS (Home Subscriber Server) type, where such profiles contain the routing rules for the SIP (Session Initiation Protocol) messages. Such profiles are defined when the customer first registers, and are administered by the operator of the IMS network.

In certain cases, an identified customer may occasionally want to activate additional routing rules and deactivate them as needed.

For example, the customer's employer can provide him/her with a connection to the employer's PABX (Private Automatic Branch eXchange) network to enable him/her to use professional talk services with his/her personal IMS subscription. Thus, the customer can decide to receive all his/her calls via the PABX when at work (whether or not on site) or may prefer to deactivate this function when at home.

Another example is the customer's option to implement advanced call transfer rules. Typically, when at home or on vacation or leave, the customer can activate rules to redirect all his/her incoming professional calls to a voicemail box and to receive all other calls.

### BACKGROUND ART

According to the prior art, to enable an adaptation of the routing rules, the identified customer is obligated to connect to the IMS network under a different identity, as the said identity would have the desired routing rules.

For example, the customer may have a personal and a professional public identity, where the latter would have professional routing rules. The customer must therefore connect to the system with one or the other identity to be able to use the routing rules associated therewith.

However, if the customer has several public identities, it is difficult for his/her potential caller to know under which identity the customer may be contacted.

Furthermore, the solution allowing for a change of identity in the prior art is neither sufficiently adaptable nor ergonomic for the customer. Indeed, the customer's choice remains limited to its number of identities while he/she may wish to connect to new services requiring a modification of his/her routing rules.

The goal of the invention is to palliate the problems of the prior art by proposing a method for the dynamic adaptation of the routing of a customer's communications in an IMS type network, where the said method does not require any change of identity on the part of the customer.

### SUMMARY

For this purpose, and according to a first aspect, the invention proposes a method for the adaptation of the routing of a customer's communications within an IMS type network, the said method providing for the customer's ability to transmit additional routing rules, and wherein the said additional routing rules are concatenated with the routing rules defined by the IMS network operator, such concatenated routing rules being subsequently available for use by the IMS network to adapt the routing of the customer's communications as a function of his/her needs.

According to a second aspect, the invention proposes an IMS type network comprising an S-CSCF function which, when a customer connects to the said network, communicates with an HSS data storage equipment to pick up the routing rules defined by the operator for the said customer, such network also comprising means enabling the customer to transmit additional routing rules, the said S-CSCF function comprising means equipped to concatenate the said additional routing rules with the routing rules defined by the operator; the network further comprising means enabling the customer to activate, deactivate, and/or modify at least one additional routing rule.

### BRIEF DESCRIPTION OF THE DRAWINGS

Other special features and advantages of the invention will become apparent in the description following below, drawn up in relation to the attached FIGURE showing part of the general architecture of an IMS network according to an embodiment of the invention.

### DESCRIPTION OF THE METHOD

The invention concerns a method for the adaptation of the routing of a customer's communications within an IMS type network and enabling the customer C dynamically to adapt his/her routing rules. In particular, the method enables the customer to adapt the routing rules for his/her communications without needing to change his/her public identity within the IMS network.

When a Customer C registers with an IMS network, his/her profile is provided based on IFC (Initial Filter Criteria) criteria, which are the implementation of the routing rules according to the specifications of the 3GPP standard. Such IFC criteria are established by the operator of the IMS network so as to define routing rules 1 for the Customer C, such rules being collected by the IMS when the Customer C registers.

The method according to the invention provides for enabling the Customer C to transmit additional routing rules 2. Such additional routing rules 2 may be transmitted by the Customer C when he/she registers with the IMS network, more particularly by being inserted in the Customer C's registration SIP message. Furthermore, the additional routing rules 2 can be transmitted in the XML (eXtensible Markup Language) format standardized according to the IFC criteria.

Moreover, the method provides for concatenation of the additional routing rules 2 with the routing rules 1 defined by the IMS network operator so as to be able to process the said routing rules together within the said network.

In particular, the routing rules 1 generated by the IFC criteria are collected by the S-CSCF (Serving-Call Session Control Function) function of the IMS network, and the concatenation of the routing rules 1, 2 can be performed as part of this function.

The concatenated routing rules 3 thus obtained can subsequently be used by the IMS network to route the customer's communications as a function of his/her needs. For example, use of the said rules 3 comprises activation of at least one additional routing rule 2, the deactivation of at least one additional routing rule 2 and/or modification of at least one additional routing rule 2.

The invention also pertains to an IMS type network as schematically represented in the FIGURE, and comprising a S-CSCF function. When a Customer C connects to the said network, the said function communicates with an HSS (Home Subscriber Server) data storage device to collect the routing rules 1 defined by the operator for the said customer.

The network also comprises means enabling the customer to transmit additional routing rules 2, the S-CSCF function comprising means equipped to concatenate the said additional routing rules 2 with the routing rules 1 defined by the operator.

The IMS network further comprises means enabling the Customer C to activate, deactivate and/or modify at least one additional rule 2 as a function of his/her needs.

Reproduced below is an example written in XML language to activate the routing of outgoing calls to the professional PABX:

```
<InitialFilterCriteria>
  <Priority>2</Priority>
  <TriggerPoint>
  <ConditionTypeCNF>1</ConditionTypeCNF>
  <SPT>
    <Group>0</Group>
    <Method>INVITE</Method>
  </SPT>
  </TriggerPoint>
  <ApplicationServer>
  <ServerName>sip:PABX@alcatel.fr</ServerName>
  <DefaultHandling>0</DefaultHandling>
  </ApplicationServer>
</InitialFilterCriteria>
```

The solution proposed by the invention has the advantage of being dynamic and of enabling the Customer C to adapt his/her IMS profile with a single identity. Naturally, this adaptation is carried out in compliance with the routing rules 1 defined by the operator, in particular by providing that the latter will have a higher priority than that of the additional routing rules 2.

Therefore, the Customer C can subscribe to services and access them by means of his/her IMS subscription without being obligated to resort to his/her operator to have it modify its connection profile.

1. Method for the adaptation of the routing of the communications of a Customer (C) within an IMS type network, the said method providing for the ability of the Customer (C) to transmit additional routing rules (2), and wherein the said additional routing rules are concatenated with the routing rules (1) defined by the IMS network operator, such concatenated routing rules (3) being subsequently available for use by the IMS network to adapt the routing of the customer's communications as a function of his/her needs.

2. Adaptation method according to claim 1, wherein the S-CSCF function of the IMS network performs the concatenation of the routing rules (1, 2).

3. Adaptation method according to claim 1, wherein the customer transmits the additional routing rules (2) when registering with the IMS network.

4. Adaptation method according to claim 3, wherein the additional routing rules (2) are inserted in the registration message SIP of Customer (C).

5. Method for adaptation according to claim 1, wherein subsequent use of the concatenated routing rules (3) comprises the activation of at least one additional routing rule (2), deactivation of at least one additional routing rule (2) and/or modification of at least one additional routing rule (2).

6. Adaptation method according to claim 1, wherein the additional routing rules (2) are transmitted in XML format.

7. IMS type network comprising an S-CSCF function which, when a Customer (C) connects to the said network, communicates with an HSS data storage equipment to pick up the routing rules (1) defined by the operator for the said customer, such network also comprising means enabling the customer to transmit additional routing rules (2), the said S-CSCF function comprising means equipped to concatenate the said additional routing rules with the routing rules (1) defined by the operator; the network further comprising means enabling the Customer (C) to activate, deactivate, and/or modify at least one additional routing rule (2).
